(19) United States
(12) Patent Application Publication
(10) Pub. No.: US 2008/0001915 A1
(43) Pub. Date: Jan. 3, 2008

(54) Input device of mobile devices

(75) Inventors: Pekka Pihlaja, Helsinki (FI); Jari Nousiainen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/479,972

(22) Filed: Jun. 30, 2006

(51) Int. Cl. G09G 5/00

(52) U.S. Cl. 345/156

(57) ABSTRACT

A rotator wheel is mounted on the device in such a way that its rim can be reached with the finger from at least one side. This enables the user to operate the rotator wheel like a roller. The rotator wheel can be equipped with sensors or switches that detect if the rotator wheel is being operated from the top, from bottom or from the side. The function assigned to the wheel can be changed accordingly.

### TECHNICAL FIELD OF THE INVENTION

This invention relates generally to an input device of portable devices, and more particularly to a rotating input device in which both rotator and roller functionality is used to input data via the user interface to the portable device.

### BACKGROUND OF THE INVENTION

There are different types of scrolling keys that are used to scroll through various lists of the menus of the portable mobile devices. The two basic types of scrolling devices on the mobile devices are a rotator and a roller. These are used for navigation in the menu and selection of items from the menu of the user interface of the mobile device.

Referring to FIG 1a there is depicted a user interface of mobile device, the user interface comprising a display unit 2 and a keyboard arrangement 10 according to prior art. The rotator wheel 4, which is also designated as a spinner, is used to scroll through the character bar when entering text and numbers, scroll through different lists and browsing messages. These scrolling functions are displayed on a display unit 2 that is part of the user interface of the mobile device as well as the rotator wheel 4. The rotator wheel 4 rotates clockwise and counter-clockwise when the user touches from above the rotator wheel 4 and spins the rotator wheel 4 with his/her finger to the desired direction. Consequently, the scrolling functionality is obtained by spinning the rotator wheel 4 to the desired direction. Typically, a selection key 7 is located in the centre of the rotator wheel. The function of the selection key depends on the guiding text 2a shown on the display beside the selection key(s). For example, if you wish to enter a phone number you have to press and hold the selection key 7. For example, you can scroll to a digit in the character bar that is shown at the bottom of the display by rotating the rotator wheel 4 and selecting it by pressing the selection key 7. You have to repeat this for each digit of the phone number. Typically, in addition to the rotator wheel 4 there are also used other separated selection keys 3a, 3b to select different selections 2a displayed on the display unit 2. For example, an upper selection key 3a to select the function displayed uppermost on the screen 2, a middle selection key 7 to select the function displayed in the middle on the screen 2, and a lower selection key 3b to select the function displayed at the bottom of the screen 2. In this example, the middle selection key 7 is the same as the centre selection key 7 of the rotator wheel 4. FIG. 1 also depicts an end key 5 and a call key 6. By pressing and holding the end key 5 it ends an active call and exits from any function. By pressing and holding the call key 6 it dials the phone number and answers a call. Reference number 1 denotes a cover of the mobile device.

FIG. 1b depicts another possibility to provide navigation capability by using a roller 8 that partly protrudes outwards on one side of the cover 1 of the mobile device. The roller 8 is the scrolling device on the side of the mobile device with press function for navigation. As an example, by rotating the roller 8 clockwise and counter-clockwise the menu items are scrolled in a list up and down, and the desired item is selected by pressing the roller 8 inwards. The roller 8 may be also used for sound volume control during the call or for moving a page during playing a multimedia message. Certain further functions may be selected if the roller 8 is pressed backwards or forwards which directions are perpendicular to pressing inwards direction. If a fold cover of mobile phone is in question, the functionality of the roller 8 may depend on the position of the flip 9, i.e. if the flip 9 is open (FIG. 1b) or closed. The conventional keyboard arrangement 10 may dispose in the flip 9, e.g. inside or outside the flip 9 when in closed position. The roller 8 according to prior art is separated from the keyboard arrangement 10 and disposes outside the keyboard arrangement 10.

The rotator wheel 4 of the prior art can be reached with the finger only from above and therefore it is accessible only if the rotator wheel 4 is freely touchable and unrestricted. If the fold or slide structure of the cover is used in the mobile device, the rotator wheel 4 is not accessible. The roller 8 of the prior art is freely accessible independent of the position of the fold or slide cover because it disposed separate from the keyboard 10. However, the separate roller 8 spends extra space from the limited surface and volume space of the mobile device and therefore the separate roller 8 is a drawback in miniaturizing of such portable devices.

The problems set forth above are overcome by providing an input device according to preferred embodiments of the invention.

### SUMMARY OF THE INVENTION

In order to overcome the problems described above preferred embodiments of the present invention provide an input device comprising a rotator wheel that is mounted on the device in such a way that its rim can be reached with a finger or other similar pointing object from at least one side. In addition to the rotator functionality this also enables the user to operate the rotator wheel like a roller, i.e. the rotator wheel can be operated from the top and from the side of the wheel. The rotator wheel according to the invention can be equipped with sensors or switches that detect if the rotator wheel is operated from the top or from the side. The function assigned to the rotator wheel can be changed accordingly.

In accordance with a first aspect of the invention there is provided an input device comprising

a rotator arranged to turn around a central point,

at least one detector arranged to detect at least one direction wherefrom the rotator is touched,

said at least one detector arranged to produce a signal as a response to the at least one direction detected, and

said rotator arranged to input an operation according to the signal produced.

In one preferred embodiment of the invention there is provided a rotator wheel comprising a rim side arranged to be accessible from at least one side.

In another preferred embodiment of the invention there is provided a rotator knob comprising an edge side arranged to be accessible from at least one side.

In still another preferred embodiments of the invention the detector is arranged to produce the signal as a response to at least one of the following directions detected: from above of the rotator, from a side of the rotator and simultaneously from two sides of the rotator.

According to one embodiment of the invention there is provided a switch arranged to be connected to the rotator to detect an actual translational sideways movement of the rotator towards the central point.

In still another preferred embodiments of the invention there is provided a keyboard arrangement of the mobile device comprising the input device.

In accordance with a second aspect of the invention there is provided a mobile device comprising

at least one cover part,

at least one display unit,

an input device arranged to be mounted to the cover part and connected to the display unit, the input device comprising
a rotator arranged to turn around a central point,
at least one detector arranged to detect at least one direction wherefrom the rotator is touched,
said at least one detector arranged to produce a signal as a response to the at least one direction detected, and
said rotator arranged to input an operation according to the signal produced.

In one preferred embodiment of the invention the rotator is arranged to be accessible from above.

In another preferred embodiment of the invention the rotator is arranged to be accessible from at least one side.

Preferably, at least one cover part comprises at least one recess configured to allow access to the rotator with a finger or other similar pointing object from at least one side of the rotator.

In still another preferred embodiment of the invention the rotator is arranged to scroll a list of items on the at least one display unit.

According to one embodiment of the invention the input device comprises a switch arranged to be connected to the rotator to detect an actual translational sideways movement of the rotator towards the central point.

Preferably, the rotator is arranged to select an item from a list displayed on the at least one display unit.

A benefit of the embodied invention provides a solution in which an input device comprising the rotator wheel is freely accessible independent of the position of the fold, slide or similar cover arrangement of the portable device.

The input device according to the invention is accessible even in the closed position of the fold or slide cover.

Another benefit of the embodied invention provides a solution in which an input device comprising the rotator wheel offers functionality of the separated roller and keyboard arrangement in the space of one input device. Therefore the input device according to the invention provides extra functionality for the rotator wheel. This space-saving solution is also preferable in miniaturizing efforts of portable devices.

### BRIEF DESCRIPTION OF THE DRAWINGS

An embodiment of the invention will be described in detail below, by way of example only, with reference to the accompanying drawings, of which

FIG. 1a depicts a block diagram of a portable device having a keyboard arrangement according to the prior art,

FIG. 1b depicts a block diagram of a portable device having a roller and a keyboard arrangement according to the prior art,

FIG. 2a depicts a block diagram of a portable device having an input device according to an embodiment of the invention,

FIG. 2b depicts a front view of the portable device of FIG. 2a where a flip or slide cover is in closed position,

FIG. 2c depicts a side view of the portable device of FIG. 2b,

FIG. 3 depicts a block diagram of a portable device having an input device according to another embodiment of the invention,

FIG. 4a depicts an end view of a portable device having an input device according to one embodiment of the invention,

FIG. 4b depicts a side view of a portable device having an input device according to second embodiment of the invention, and

FIG. 4c depicts a side view of a portable device having an input device according to third embodiment of the invention.

### DETAILED DESCRIPTION OF THE INVENTION

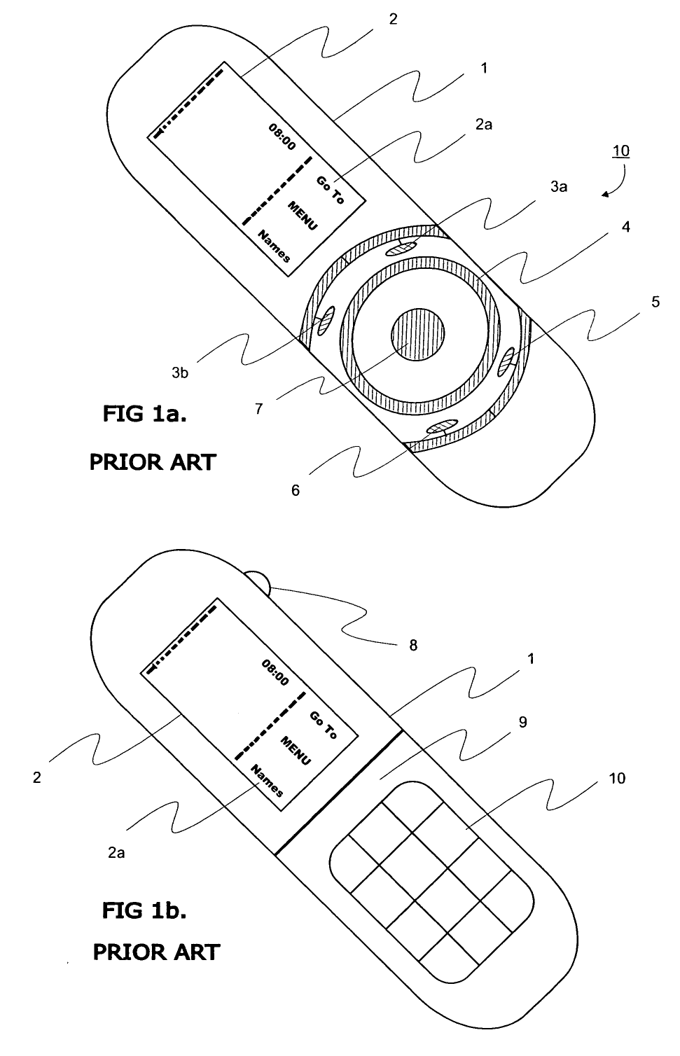

A description of FIGS. 1a and 1b was given earlier in connection with the description of the state of art.

A rotator according to this invention is a rotating object that is arranged to turn around a central point so that the object can be in rotary motion clockwise and counter-clockwise around the central point. The rotator is an object that has an upper side, bottom side and side wall(s). The side wall can be e.g. in a form of a rim or edge. The rotators can be e.g. a rotator wheel, rotator knob or similar rotating object. In addition to the rotary motion the rotator according to this invention can be arranged to make a translatory motion when there is arranged a switch arrangement for example in connection with the central point to allow such translational sideways movement.

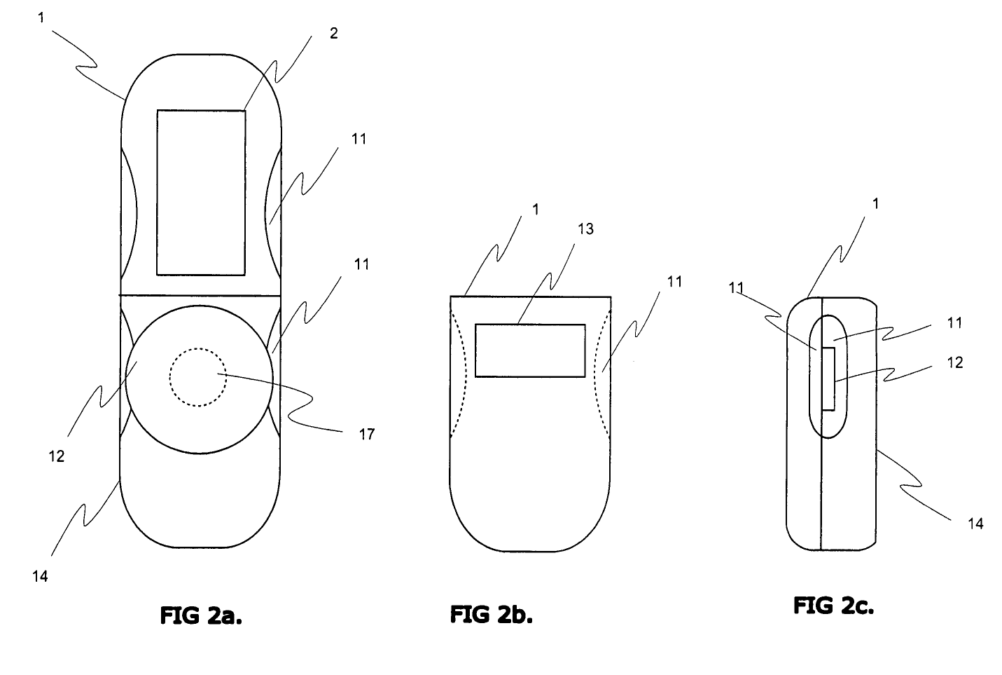

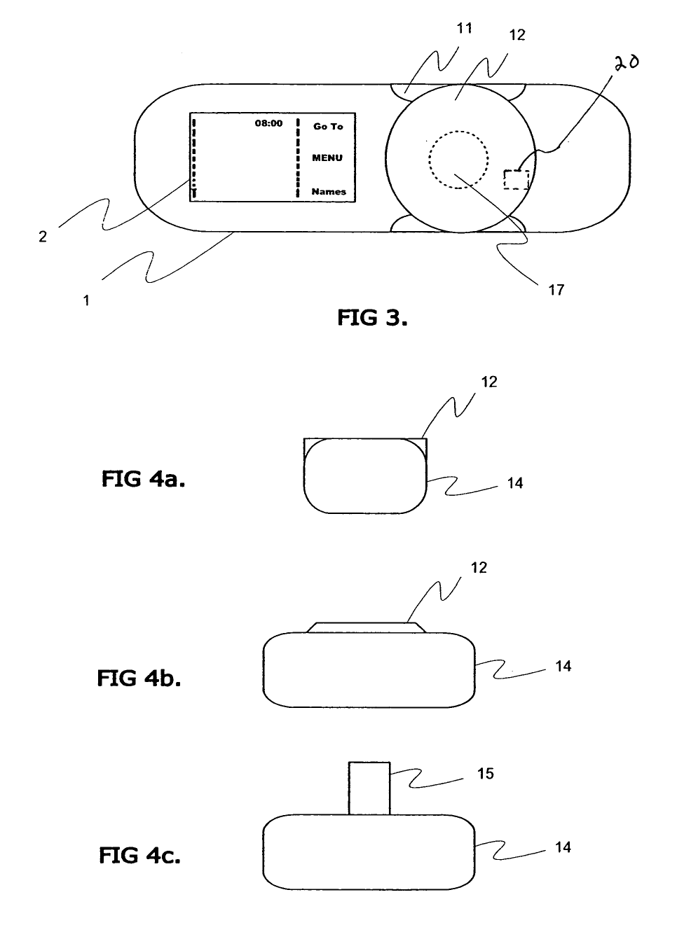

FIG. 2a depicts a block diagram of a portable device having an input device according to an embodiment of the invention. There is shown a mobile phone of fold model having two separate covers 1, 14 that are hinged to each other so that the covers 1, 14 can be folded against each other as shown in FIG. 2c. Similarly a portable device can be a mobile phone of a slide model (not shown) in which the two covers 1, 14 are arranged to slide against each other to have a position similar to that shown in FIG. 2c. In the latter embodiment the covers 1, 14 comprises a slide arrangement so that the covers 1, 14 are arranged to slide into a position shown in FIG. 2c. The portable device shown in FIG. 2a comprises a display unit 2 and a rotator 12, e.g. a rotator wheel or rotator knob. Further, the portable device may comprise another display unit 13 that is used when the device is in a closed position according to FIG. 2b. The portable device, preferably a mobile phone, is shown in FIG. 2a in its opened position. The rotator 12 enables the user to operate the rotator both from above and from any side of the rotator 12 when the mobile device of the fold or slide model is in opened position. If the mobile device is a one-block device as shown in FIG. 3 the above also applies.

Further, there is depicted at least one recess 11 near the edge of the cover 1, 14. As an example, there is shown two recesses in each cover 1, 14 in FIG. 2a. Alternatively, there can be just one recess 11 in each cover 1, 14 on the same side of the portable device. These recesses 11 are so disposed that when the mobile phone is in its closed position, as shown in FIG. 2b and 2c, the two recesses 11 of the same side in the edges of the covers 1, 14 are adjusted against each other as shown in FIG. 2c. These recesses 11 enable the user to operate the rotator 12 like a roller because they allow the user to access the rotator 12 with a finger or other similar pointing object from both the left and right side of the rotator 12 even when in the closed position for the mobile device of the fold or slide model. The rotator 12 is mounted on the mobile device in such a way that its edge or rim can be reached with the finger or other similar pointing object from at least one side. By adjusting the dimensions of the recesses 11 to match with the size of the rotator 12 such that the rotator side is accessible with the finger, there is a wide variety of rotator sizes to choose. If the mobile device is a one-block device as shown in FIG. 3 and the rotator 12 is embedded inside the block, the above also applies.

FIG. 4a-4c depict end and side views of a portable device having an input device according to some embodiments of the invention. The possible recess 11 arrangements are not shown in FIGS. 4a-4c, but they are applicable in each of the following embodiments of the invention as described earlier in this specification. FIG. 4a shows an embodiment of the invention where a rotator 12, preferably a rotator wheel, is mounted flush with the cover 14 of the mobile device. In this embodiment the diameter of the rotator wheel 12 has to be big enough to reach the edges of the cover 14 so that the rim or edge of the rotator wheel 12 is accessible from the side. FIG. 4b shows another embodiment of the invention where a rotator 12, preferably a rotator wheel, is mounted on top of the cover 14 of the mobile device. In this embodiment the diameter of the rotator wheel 12 is not limited to reach the edges of the cover 14 so that the rim of the rotator wheel 12 is accessible from the side. Especially, if the rim or edge is slanted, the rotator wheel 12 can be operated from the side although it does not reach the edges of the portable device. Therefore, the diameter of the rotator wheel 12 does not limit the width of the portable device. FIG. 4c shows an embodiment of the invention where a rotator 12, preferably a rotator knob 15, is mounted on top of the cover 14 of the mobile device.

All embodiments of the input devices described earlier are used as a keyboard or keyboard arrangement of the portable device. The input device according to the invention comprises both the rotator and roller type keyboard functionality. The rotator and roller type keyboard functionality according to the invention is combined to the one and same input device. In the prior art solutions the rotator and roller type functionality is applied by separate keyboard arrangements.

The input device according to the invention is equipped with at least one detector 20 (shown in phantom in FIG. 3 with a similar detector not shown, but nevertheless present in the embodiment of FIG. 4a-4c) that detects from which direction the input device comprising the rotator 12 is operated e.g. with the user's finger. The detector can be for example a sensor, switch or similar detector that detects contact, touch, proximity, movement or other such physical property aligned to the detector. For example, the detector can be a capacitive sensor or switch that detects a finger's or other similar pointing object's contact on the edge or rim of the rotator, e.g. a rotator wheel 12 or rotator knob 15. According to an embodiment of the invention the rotator 12 comprises at least one detector 17 as shown in FIGS. 2a and 3. Alternatively the detector is disposed near the rotator within the area of the input device. According to another embodiment of the invention a mechanical switch (not shown) can be used to detect the actual translational sideways movement of the rotator 12. The translatory motion sideways is applied to a different direction than the clockwise or counter-clockwise rotary motion of the rotator 12.

In the following the different functional modes of the input device according to the invention is described in more detail. The input device comprising the rotator 12 can be reached with the finger or other similar pointing object from at least one side of the rotator 12 as explained earlier in this description. The direction of access is detected by the appropriate detector or detectors 17 associated with the rotator 12. According to a first embodiment of the invention the rotator 12 can be reached with the finger or other similar pointing object from above. According to a second embodiment of the invention the rotator 12 can be reached with the finger or other similar pointing object from under. According to a third embodiment of the invention the rotator 12 can be reached with the finger or other similar pointing object from at least one side of the rotator 12, e.g. from left side or right side, from front side or behind, etc. According to a fourth embodiment of the invention the rotator 12 can be reached with the finger or other similar pointing object from two sides of the rotator 12 simultaneously, e.g. from left side and right side, from front side and from behind, etc. According to a fifth embodiment of the invention the rotator 12 can be reached with the finger or other similar pointing object from above and under of the rotator 12 simultaneously. According to a sixth embodiment of the invention the rotator 12 can be reached with the finger or other similar pointing object from at least one side of the rotator 12 and from above simultaneously, e.g. from above and from left side or right side or front side or behind, etc. According to a seventh embodiment of the invention the rotator 12 can be reached with the finger or other similar pointing object from at least one side of the rotator 12 and from under simultaneously, e.g. from under and from left side or right side or front side or behind, etc. The first, third, fourth and sixth embodiments are easily applicable if the portable device is the one-block model of FIG. 3 or if the fold or slide model is in opened position as shown in FIG. 2a. The first and sixth embodiments are also applicable if the fold or slide model is in closed position as shown in FIG. 2b when the rotator 12 is arranged to be accessible from above. The second and seventh embodiments are also applicable if the fold or slide model is in closed position as shown in FIG. 2b when the rotator 12 is arranged to be accessible from under. The fifth embodiment is also applicable if the fold or slide model is in closed position as shown in FIG. 2b when the rotator 12 is arranged to be accessible from above and from under simultaneously. For example there is arranged to be a hole (not shown) in one or both of the covers 1, 14 of the folded or slid mode device or the recesses 11 of the covers 1, 14 are so designed that rotator 12 is accessible from above or under or both. The third and fourth embodiments of the invention are always applicable both in opened position and in closed position of the cover 1, 14.

Above-mentioned first to seventh embodiments are applicable to different functional modes of the input device according to the invention. A function assigned to the input device can be changed accordingly, i.e. according to the direction wherefrom the input device is operated. Therefore, the input device has a first functionality when it is operated from above direction according to the first embodiment described above, a second functionality when it is operated from under direction according to the second embodiment described above, a third functionality when it is operated from a direction of at least one side according to the third embodiment described above, and so on ending with a seventh functionality when it is operated from a direction of at least one side of the rotator 12 and a direction of from under simultaneously according to the first embodiment described above. In addition to above-mentioned embodiments there is a possibility to each of the first to seventh embodiments an additional functionality with the actual translatory sideways motion made by a finger or similar pointing object as earlier described. As an example, this translatory motion can be a select function after a desired selection of an item has been made according to one of the first to seventh embodiment described above.

Referring to FIGS. 2a and 2b a following small example of a plurality of functionality possibilities can be given. When the portable device of the fold or slide model device is operated in the opened position and the user touches the rotator 12 from above, a list displayed on the inner display unit 2 can be scrolled if the user rotates the rotator 12 clockwise or counter-clockwise. When the same device is operated in the closed position and the user touches the rotator 12, e.g. from the right side, a list displayed on the outer display unit 13 can be scrolled if the user rotates the rotator 12 clockwise or counter-clockwise. And further, when the same device is operated in the closed position and the user touches the rotator 12 from the left side, a sound volume is controlled if the user rotates the rotator 12 clockwise or counter-clockwise.

While this invention has been described with reference to illustrative embodiments, this description is not intended to be construed in a limiting sense. Various other embodiments of the invention will be apparent to persons skilled in the art upon reference to this description. It is therefore contemplated that the appended claims will cover any such modifications of the embodiments as fall within the true scope and spirit of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An input device comprising
a rotator arranged to turn around a central point,
at least one detector arranged to detect at least one direction wherefrom the rotator is touched,
said at least one detector arranged to produce a signal as a response to the at least one direction detected, and
said rotator arranged to input an operation according to the signal produced.

2. The input device according to claim 1, wherein the rotator is a rotator wheel comprising a rim side arranged to be accessible from at least one side.

3. The input device according to claim 2, wherein the rim side is arranged to slant.

4. The input device according to claim 1, wherein the rotator is a rotator knob comprising an edge side arranged to be accessible from at least one side.

5. The input device according to claim 1, wherein the detector is arranged to produce the signal as a response to a direction detected from above of the rotator.

6. The input device according to claim 1, wherein the detector is arranged to produce the signal as a response to a direction detected from a side of the rotator.

7. The input device according to claim 1, wherein the detector is arranged to produce the signal as a response to a direction detected simultaneously from two sides of the rotator.

8. The input device according to claim 1, wherein the rotator includes the at least one detector.

9. The input device according to claim 1, wherein the detector is at least one of the following detectors: a sensor and a switch.

10. The input device according to claim 1, wherein a switch is arranged to be connected to the rotator to detect an actual translational sideways movement of the rotator towards the central point.

11. The input device according to claim 1, wherein the rotator is arranged to be connected to a processor of a portable device and the rotator is arranged to input data to the portable device.

12. A keyboard arrangement of a mobile device, comprising the input device according to claim 1.

13. A mobile device comprising
at least one cover part,
at least one display unit,
an input device arranged to be mounted to the cover part and connected to the display unit, the input device comprising
a rotator arranged to turn around a central point,
at least one detector arranged to detect at least one direction wherefrom the rotator is touched,
said at least one detector arranged to produce a signal as a response to the at least one direction detected, and
said rotator arranged to input an operation according to the signal produced.

14. The mobile device according to claim 13, wherein the rotator is arranged to be accessible from above.

15. The mobile device according to claim 13, wherein the rotator is arranged to be accessible from at least one side.

16. The mobile device according to claim 13, wherein the at least one cover part comprises at least one recess configured to allow access to the rotator with a finger from at least one side of the rotator.

17. The mobile device according to claim 16, wherein the input device is arranged to be attached to a first cover part that is folded against a second cover part, the first and second cover parts having recesses configured to allow access to the rotator with a finger from at least one side of the rotator.

18. The mobile device according to claim 16, wherein the input device is arranged to be attached to a first cover part that is slid over a second cover part, the first and second cover parts having recesses configured to allow access to the rotator with a finger from at least one side of the rotator.

19. The mobile device according to claim 13, wherein a first display unit is arranged to operate with a first direction detected and a second display unit is arranged to operate with a second direction detected.

20. The mobile device according to claim 13, wherein the rotator is arranged to scroll a list of items on the at least one display unit.

21. The mobile device according to claim 13, wherein the rotator is arranged to control a sound volume controller.

22. The mobile device according to claim 13, wherein the input device comprises a switch arranged to be connected to the rotator to detect an actual translational sideways movement of the rotator towards the central point.

23. The mobile device according to claim 22, wherein the rotator is arranged to select an item from a list displayed on the at least one display unit.

24. The mobile device according to claim 13, wherein the rotator is arranged to be mounted flush with the at least one cover part.

25. The mobile device according to claim 13, wherein the rotator is arranged to be mounted on top of the at least one cover.

26. The mobile device according to claim 13, wherein the rotator is arranged to be a rotator wheel.

27. The mobile device according to claim 13, wherein the rotator is arranged to be a rotating knob.

28. A method comprising
arranging a rotator to turn around a central point,
detecting at least one direction wherefrom the rotator is touched,
producing a signal as a response to the detecting, and
arranging to input an operation according to the produced signal.

29. The method of claim 28, wherein the producing a signal is in response to a direction detected from above the rotator.

30. The method of claim 28, wherein the producing a signal is in response to a direction detected from a side of the rotator.

31. The method of claim 28, wherein the producing a signal is in response to a direction detected simultaneously from two sides of the rotator.

32. An input device comprising
a rotator arranged to turn around a central point,
means for detecting at least one direction wherefrom the rotator is touched,
said means for detecting arranged to produce a signal as a response to the at least one direction detected, and
said rotator arranged to input an operation according to the signal produced.

33. The input device according to claim 32, wherein the rotator is a rotator wheel comprising a rim side arranged to be accessible from at least one side.

34. The input device according to claim 33, wheein the rim side is arranged to slant.
